(19) United States
(12) Patent Application Publication
(10) Pub. No.: US 2019/0120563 A1
(43) Pub. Date: Apr. 25, 2019

(54) HEAT EXCHANGER AND THERMAL MANAGEMENT FACILITY FOR BATTERIES OF ELECTRIC OR HYBRID VEHICLES

(71) Applicant: Valeo Systemes Thermiques, Le Mesnil Saint Denis (FR)

(72) Inventors: Dinh-Luyen Nguyen, Le Mesnil Saint-Denis (FR); Karim Arab, Le Mesnil Saint-Denis (FR); Kamel Azzouz, Le Mesnil Saint Denis (FR); Jérémy Blandin, Le Mesnil Saint Denis (FR)

(73) Assignee: Valeo Systemes Thermiques, Le Mesnil Saint Denis (FR)

(21) Appl. No.: 15/559,661

(22) PCT Filed: Mar. 21, 2016
(86) PCT No.: PCT/EP2016/056178

§ 371 Date: Sep. 19, 2017

(30) Foreign Application Priority Data
Mar. 20, 2015 (FR) 1552312

(51) Int. Cl. F28D 9/00; B60H 1/00; H01M 10/625; H01M 10/6568

(52) U.S. Cl. CPC F28D 9/0056; B60H 1/00278; F28D 2021/008; H01M 10/6568; H01M 10/625

(57) ABSTRACT

The present invention concerns a heat exchanger (1; 1′) including a circulation device (2) for a first heat-transfer fluid including a first-heat-transfer-fluid inlet (3) and a first-heat-transfer-fluid outlet (4) between which a first heat-transfer fluid is designed to flow, characterized in that it includes a housing (5) containing the circulation device (2) for a first heat-transfer fluid, the housing (5) including:
at least one opening (7) designed to be traversed by the first-heat-transfer-fluid inlet and outlet (3, 4) of the circulation device (2) for a first heat-transfer fluid,
a second-heat-transfer-fluid inlet (8) and a second-heat-transfer-fluid outlet (9) between which a second heat-transfer fluid is designed to flow.

The present invention also concerns a thermal management facility (100) for batteries of electric or hybrid vehicles.

The present invention concerns a heat exchanger and a thermal management facility for batteries of electric or hybrid vehicles.

The thermal regulation of batteries, in particular in the domain of motor vehicles, has to be closely controlled. Indeed, the range of a battery can decrease significantly if subjected to low temperatures. Furthermore, damage may be caused if a battery is exposed to excessively high temperatures.

In order to regulate the temperature of a battery, it is common to use heat exchangers using heat-transfer fluids that are in direct contact with the battery. The heat-transfer fluids can thus absorb the heat emitted by the battery or batteries in order to cool same and to remove said heat, for example via one or more other heat exchangers.

Some heat exchangers, referred to as dual-flow fluid heat exchangers, have first and second tubes stacked alternately in contact with one another.

A first heat-transfer fluid flows in the first tubes and a second heat-transfer fluid flows in the second tubes. The heat exchanger thereby enables heat-exchange via the tubes between the first heat-transfer fluid, usually a coolant, and the second heat-transfer fluid, such as cooling water.

However, the efficiency of the heat-exchange is limited by the shared exchange surface of the first and second tubes.

Moreover, the aggregate thicknesses of the walls of the first and second tubes generate significant thermal resistance, limiting the heat exchange.

Furthermore, such a heat exchanger may be significantly heavy and expensive.

One of the objectives of the present invention is therefore to at least partially overcome the drawbacks in the prior art by proposing an improved heat exchanger and an improved thermal management facility.

For this purpose, the present invention relates to a heat exchanger including a circulation device for a first heat-transfer fluid including a first-heat-transfer-fluid inlet and a first-heat-transfer-fluid outlet between which a first heat-transfer fluid is designed to flow, characterized in that it includes a housing containing the circulation device for a first heat-transfer fluid, the housing including:
at least one opening designed to be traversed by the first-heat-transfer-fluid inlet and outlet of the circulation device for a first heat-transfer fluid,
a second-heat-transfer-fluid inlet and a second-heat-transfer-fluid outlet between which a second heat-transfer fluid is designed to flow.

Thus, the circulation device for a first heat-transfer fluid is immersed in the second heat-transfer fluid. The heat-exchange surface is thus increased. The thermal resistance between the second heat-transfer fluid and the circulation device for a first heat-transfer fluid is reduced. Furthermore, the volume, weight, number of components and cost of the heat exchanger are all reduced.

According to one or more features of the heat exchanger, taken individually or in combination:
the circulation device for a first heat-transfer fluid has at least two superimposed heat-exchange tubes,
the heat-exchange tube forms at least one half turn,
the first heat-transfer fluid is designed to flow in parallel in the superimposed heat-exchange tubes,
the heat-exchange tubes are flat,
the circulation device for a first heat-transfer fluid has at least one insert interposed between two superimposed heat-exchange tubes of the circulation device for a first heat-transfer fluid,
the circulation device for a first heat-transfer fluid has at least one insert interposed between one heat-exchange tube and the cover of the housing,
the circulation device for a first heat-transfer fluid has at least one insert interposed between one heat-exchange tube and the bottom of the housing,
the insert has an overall corrugated shape,
the insert is in contact with a lower and/or upper heat-exchange tube along a plurality of straight parallel lines,
the at least one opening designed to be traversed by the first-heat-transfer-fluid inlet and outlet is arranged on one face of the housing perpendicular to a lateral face in which the second-heat-transfer-fluid inlet and/or outlet are arranged,
the second-heat-transfer-fluid inlet and outlet are arranged opposing lateral faces of the housing. Thus, the second heat-transfer fluid flows naturally from the second-heat-transfer-fluid inlet to the second-heat-transfer-fluid outlet arranged to face same. The pressure drop in the second heat-transfer fluid is thereby reduced.
the second-heat-transfer-fluid inlet and outlet are arranged on a single lateral face of the housing. The flow of the second heat-transfer fluid ceases to be natural, but is forced into a U shape. This increases the flow time of the second heat-transfer fluid in the housing, which increases the heat-exchange with the circulation device for a first heat-transfer fluid.
the housing has a cover and a bottom that are each provided with complementary attachment means,
the complementary attachment means are snap-fitting means,
the heat exchanger includes a first ring seal interposed between the cover and the bottom of the housing,
one part of the housing, either the bottom or the cover, has a U-shaped peripheral end, a first arm of the U bearing the attachment means, the first ring seal being interposed between the second arm of the U and the peripheral end of the other part of the housing bearing the complementary attachment means,
the heat exchanger has a second ring seal interposed between the opening in the housing and the first-heat-transfer-fluid inlet and outlet of the circulation device for a first heat-transfer fluid.

The invention also relates to a thermal management facility for batteries of electric or hybrid vehicles, characterized in that it includes a heat exchanger as described above, in which:
the first-heat-transfer-fluid inlet and outlet are connected to an air-conditioning circuit,
the second-heat-transfer-fluid inlet and outlet are connected to a cooling water circuit for cooling the batteries.

Other characteristics and advantages of the invention will become more clearly apparent on reading the description below, given by way of non-limiting example and the attached drawings, in which:

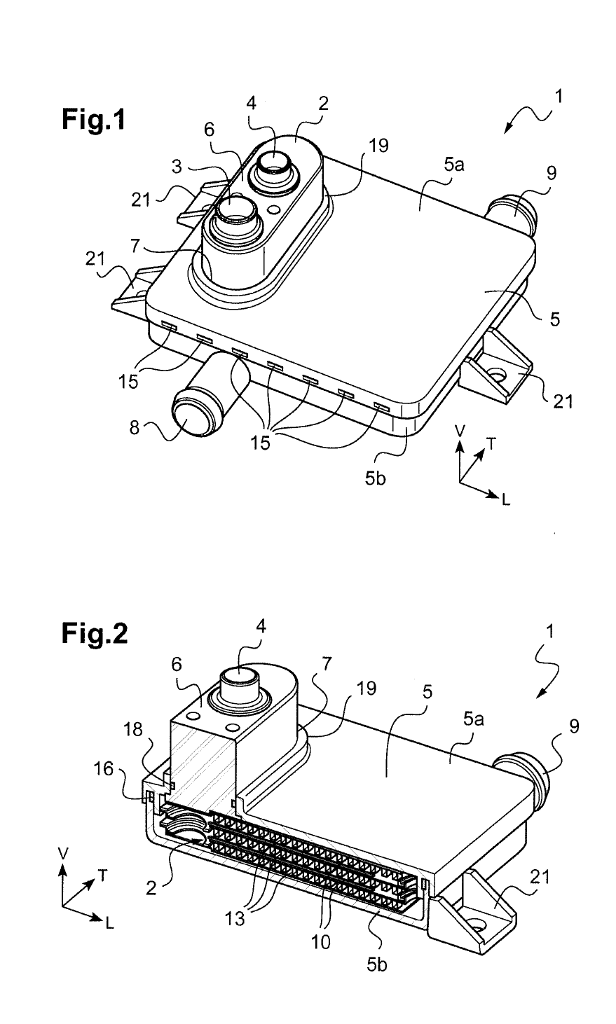

FIG. 1 is a schematic perspective view of a first example embodiment of a heat exchanger in the assembled state,

FIG. 2 is a cross section of the heat exchanger in FIG. 1, taken along a vertical plane (L, V),

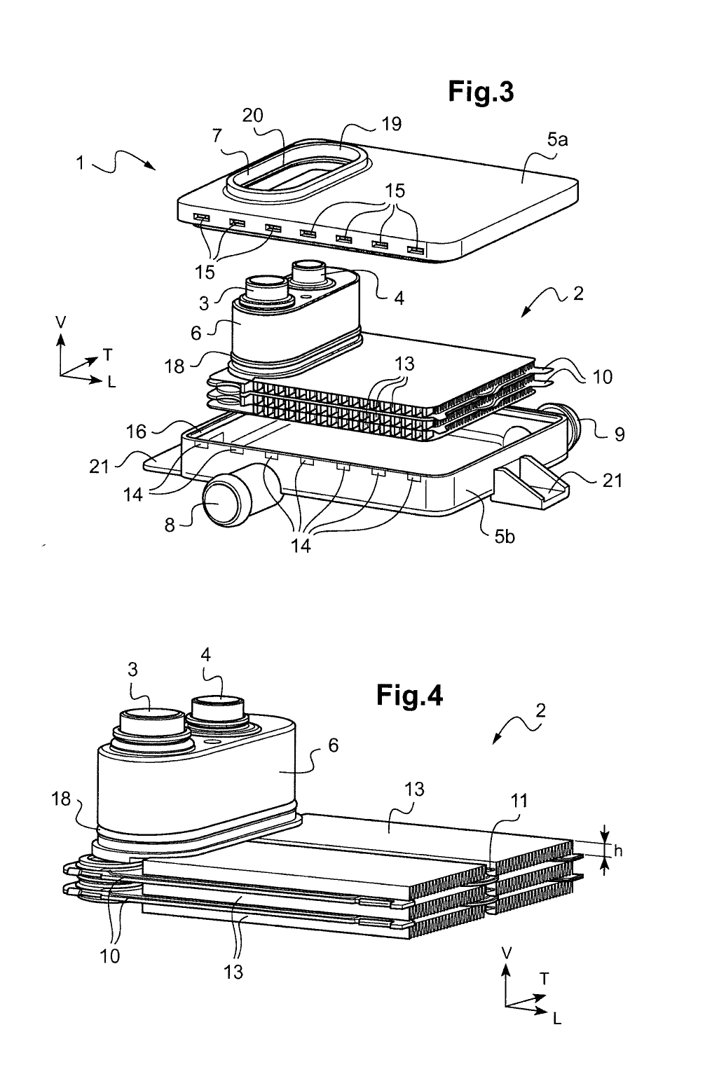

FIG. 3 is a schematic exploded view of the heat exchanger in FIG. 1,

FIG. 4 shows an example embodiment of a circulation device for a first heat-transfer fluid,

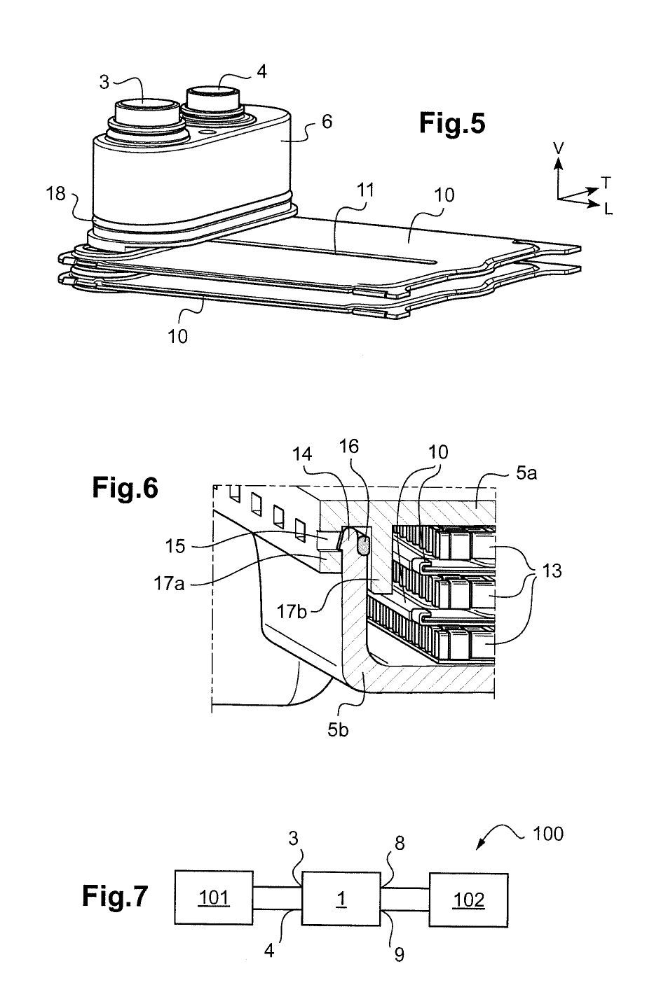

FIG. 5 shows the circulation device for a first heat-transfer fluid in FIG. 4 with no inserts,

FIG. 6 shows a magnified cross section of a detail of the heat exchanger in FIG. 1,

FIG. 7 is a schematic view of a thermal management facility for batteries of electric or hybrid vehicles,

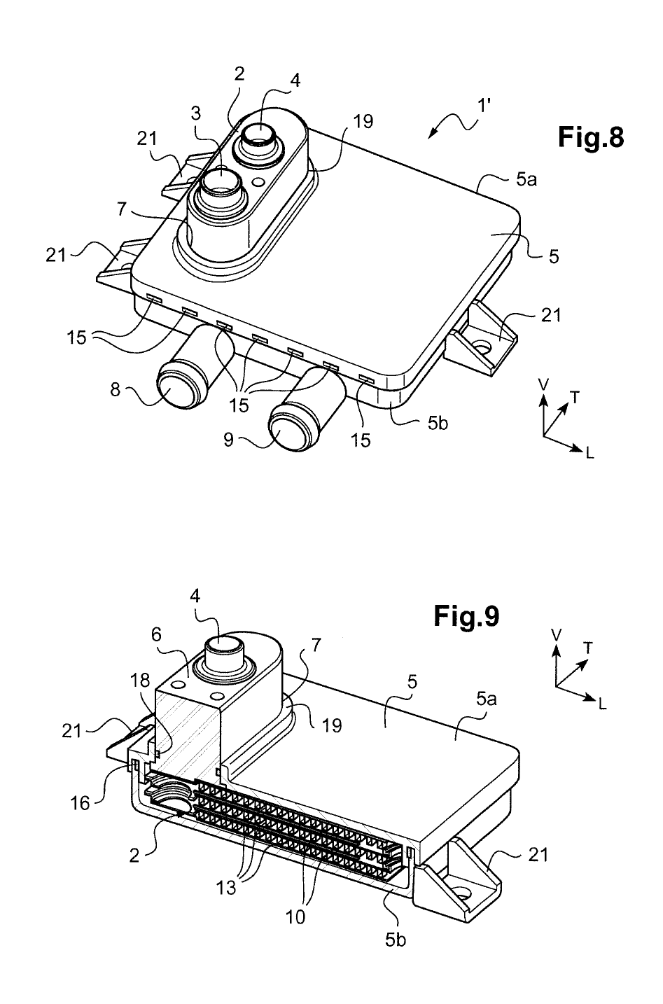

FIG. 8 is a schematic perspective view of a second example embodiment of a heat exchanger in the assembled state,

FIG. 9 is a cross section of the heat exchanger in FIG. 8, taken along a vertical plane (L, V), and

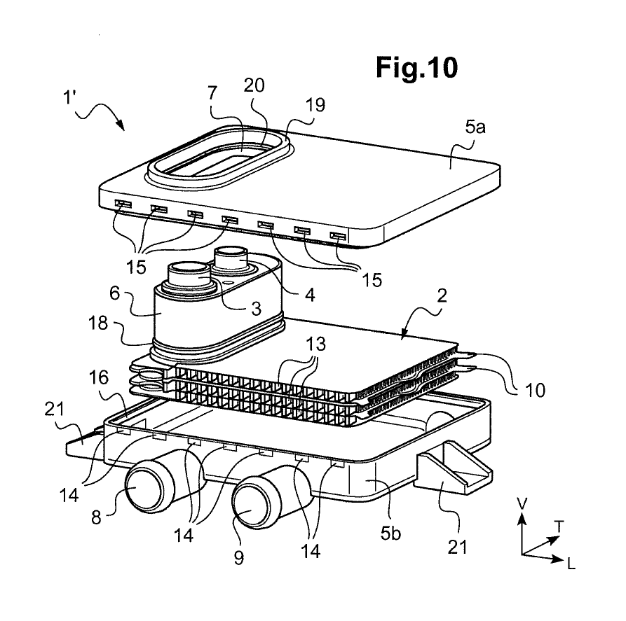

FIG. 10 is a schematic exploded view of the heat exchanger in FIG. 8.

In these figures, identical elements are indicated using the same reference numbers.

In the remainder of the description, the lengthwise, vertical and crosswise directions indicated in FIG. 1 by the axes L, V, T, which are static in relation to the heat exchanger 1, 1′, are used, without limiting the invention.

FIGS. 1 to 3 show a first embodiment of a heat exchanger 1 that is for example designed to cool and remove heat from batteries of an electric or hybrid vehicle.

The heat exchanger 1 includes a circulation device 2 for a first heat-transfer fluid including a first-heat-transfer-fluid inlet 3 and a first-heat-transfer-fluid outlet 4 between which a first heat-transfer fluid is designed to flow.

The heat exchanger 1 also includes a housing 5 that is for example made of plastic.

The housing 5 is essentially hollow and forms a seat designed to receive the circulation device 2 for a first heat-transfer fluid. The housing is for example a parallelepiped.

According to an example embodiment, the housing 5 is formed by two housing parts: a cover 5a and a bottom 5b that are assembled together along a substantially longitudinal median vertical plane.

The housing 5 also includes at least one opening 7 designed to be traversed by the first-heat-transfer-fluid inlet and outlet 3, 4 as well as a second-heat-transfer-fluid inlet 8 and a second-heat-transfer-fluid outlet 9 between which a second heat-transfer fluid is designed to flow.

The first heat-transfer fluid is for example a coolant, such as a halogenated hydrocarbon, such as 1,1,1,2-Tetrafluoroethane (also known as R134a). The first heat-transfer fluid is for example in liquid or gas phase or a mixture of both liquid and gas phases, for example under a pressure of around 4 or 5 bars.

The second heat-transfer fluid is for example a coolant, such as water that may contain an additive such as ethylene glycol or propylene glycol designed to increase the boiling temperature and/or resistance to freezing.

Thus, the circulation device 2 for a first heat-transfer fluid is immersed in the second heat-transfer fluid. The heat-exchange surface is thus increased. The thermal resistance between the second heat-transfer fluid and the circulation device 2 of a first heat-transfer fluid is reduced. Furthermore, the volume, weight, number of components and cost of the heat exchanger 1 are all reduced.

As shown more clearly in FIGS. 2 to 5, the circulation device 2 for a first heat-transfer fluid includes for example several superposed heat-exchange tube 10 (two in the example), which are for example identical. The first heat-transfer fluid is designed to flow in parallel in the superimposed heat-exchange tubes 10.

More specifically, a heat-exchange tube 10 has an intermediate inlet and an intermediate outlet between which the first heat-transfer fluid is designed to flow. The first-heat-transfer-fluid inlet 3 is connected to the intermediate inlets of the heat-exchange tubes 10. The first-heat-transfer-fluid outlet 4 is connected to the intermediate outlets of the heat-exchange tubes 10.

According to one embodiment, the heat-exchange tube 10 forms at least one half turn such that the first heat-transfer fluid flows in a U shape or a succession of alternating U shapes in each heat-exchange tube 10. Thus, in the example shown in FIG. 5, the superposed heat-exchange tubes 10 are U shaped, the intermediate inlets and outlets being located on a single side of the heat-exchange tube 10.

According to an example embodiment, the heat-exchange tubes 10 are flat, which helps to save space with a larger exchange surface. The heat-exchange tubes are for example formed of two stamped plates assembled together, having respectively an overall rectangular shape. The U-shaped heat-exchange tubes 10 formed from stamped plates for example include at least one central gap 11 in a lengthwise direction L separating the intermediate inlet from the intermediate outlet.

The circulation device 2 for a first heat-transfer fluid may also include inserts 13 interposed between the superposed heat-exchange tubes 10, between the first heat-exchange tube 10 and the bottom 5b of the housing 5 and between the last heat-exchange tube 10 and the cover 5a of the housing 5.

The inserts 13 form a three-dimensional space between two adjacent superposed heat-exchange tubes 10 in which the second heat-transfer fluid can flow. The height h of the insert 13 (or the distance between two heat-exchange tubes 10) may for example be between 2 mm and 4 mm, such as to form a hydraulic diameter of between 0.8 mm and 1 mm (FIG. 4).

This forms an alternating stack of heat-exchange tubes 10 and inserts 13. Thus, in the example shown in FIG. 2, the heat exchanger 1 includes three inserts 13 and two heat-exchange tubes 10 arranged alternately between the cover 5a and the bottom 5b of the housing 5b.

The insert 13 is for example in contact with a lower and/or upper heat-exchange tube 10 along a plurality of straight parallel lines. The lines may extend in a lengthwise direction L of flow of the fluid, as in the example shown in FIGS. 2 and 3, or in a crosswise direction T that is perpendicular to said lengthwise direction L (FIG. 4), which helps to further increase the heat-exchange time and therefore the performance of the heat exchanger.

The inserts 13 for example have an overall corrugated shape. The inserts 13 are for example attached to the heat-exchange tubes 10 at the tops of the corrugations.

The heat-exchange tubes 10 and the inserts 13 are for example made of metal, for example an aluminum alloy, to withstand the pressure of the first heat-transfer fluid. The heat-exchange tubes 10 and the inserts 13 are for example brazed together.

In addition to enabling the second heat-transfer fluid to flow, the inserts 13 help to increase the heat-exchange surface between the first heat-transfer fluid flowing in the circulation device 2 for a first heat-transfer fluid and the second heat-transfer fluid flowing in the housing 5. The inserts 13 also guide the flow of the second heat-transfer fluid from the second-heat-transfer-fluid inlet 8 towards the second-heat-transfer-fluid outlet 9.

Once the heat-exchange tubes 10 and the inserts 13 have been assembled together, the circulation device 2 for a first heat-transfer fluid is then a one-piece component and can therefore be handled and easily assembled in the housing 5 (FIG. 4).

The opening 7 in the housing 5 designed to be traversed by the first-heat-transfer-fluid inlet and outlet 3, 4 is for example oblong shaped. The first-heat-transfer-fluid inlet and outlet 3, 4 are for example arranged in a one-piece base 6 of complementary shape.

The opening 7 is for example arranged on one face of the housing 5 (cover 5a or the bottom 5b) that is perpendicular to a lateral face in which the second-heat-transfer-fluid inlet and outlet 8, 9 are arranged.

The second-heat-transfer-fluid inlet and outlet 8, 9 may be arranged on opposing lateral faces of the housing 5 (FIG. 1). Thus, the second heat-transfer fluid flows naturally from the second-heat-transfer-fluid inlet 8 to the second-heat-transfer-fluid outlet 9 arranged to face same. The pressure drop in the second heat-transfer fluid is thereby reduced.

The second-heat-transfer-fluid inlet and outlet 8, 9 are for example formed as a single part with one part of the housing, either the cover 5a or the bottom 5b.

The second-heat-transfer-fluid inlet and outlet 8, 9 for example have a respective nozzle designed to be inserted in a hydraulic pipe by elastic deformation of the pipe for the supply and back flow of the second heat-transfer fluid.

According to an example embodiment, the cover 5a and the bottom 5b are respectively provided with complementary attachment means, that are for example carried by a lower attachment portion of the cover 5a and by an upper attachment portion of the bottom 5b.

The complementary attachment means are for example screwing means or snap-fitting means to laterally clip the cover 5a to the bottom 5b of the housing 5.

According to one example embodiment, the complementary snap-fitting means include laterally projecting lugs 14 and complementary notches 15 that cooperate by elastic lateral interlocking to enable mutual attachment (also referred to as snap-fitting means).

The complementary attachment means may be arranged only along the lengths of the housing 5. For example, there may be seven complementary attachment means on each length of the housing 5 (FIGS. 1 and 3).

Furthermore, the heat exchanger 1 includes a first ring seal 16 interposed between the cover 5a and the bottom 5b of the housing 5.

According to an example embodiment, one part of the housing, either the bottom 5b or the cover 5a, has a U-shaped peripheral end. The first arm of the U bears the attachment means. The first ring seal 16 is interposed between the second arm of the U and the peripheral end of the other part of the housing bearing the matching attachment means.

For example and as shown more clearly in FIG. 6, the cover 5a has a U-shaped peripheral end. The outer arm 17a bears the attachment means, for example notches 15. The first ring seal 16 is interposed between the inner arm 17b and the peripheral end of the bottom 5b bearing the lug 14.

The back of the side wall bearing the lug 14 may have an inner face designed to partially fit the toroidal shape of the first ring seal 16.

According to an example embodiment, the heat exchanger 1 has a second ring seal 18 interposed between the opening 7 in the housing 5 and the first-heat-transfer-fluid inlet and outlet 3, 4.

The opening 7 for example has a vertically projecting edge 19. An annular slot 20 may be formed in the edge 19 to receive the second ring seal 18 arranged about the base 6 of the first-heat-transfer-fluid inlet and outlet 3, 4.

The housing 5 may also have attachment brackets 21, that are for example provided with holes, for attaching the heat exchanger 1, for example using screws.

According to an example embodiment shown schematically in FIG. 7, the heat exchanger 1 is built into a thermal management facility 100 for the batteries of an electric or hybrid vehicle. The first-heat-transfer-fluid inlet and outlet 3, 4 are connected to an air-conditioning circuit 101 and the second-heat-transfer-fluid inlet and outlet 8, 9 are connected to a cooling water circuit 102 for cooling the batteries.

When in operation, the heat exchanger 1 enables heat to be exchanged between the first heat-transfer fluid and the second heat-transfer fluid. In the example, the coolant of the air-conditioning circuit cools the cooling water, thereby cooling the batteries by capturing the heat required for the phase change of the first heat-transfer fluid by evaporation.

FIGS. 8 to 10 show a second embodiment.

The heat exchanger 1′ differs from the one described above in that the second-heat-transfer-fluid inlet and outlet 8, 9 are arranged on a single lateral face of the housing 5.

The inserts 13 guide the flow of the second heat-transfer fluid from the second-heat-transfer-fluid inlet 8 towards the second-heat-transfer-fluid outlet 9.

Thus, the flow of the second heat-transfer fluid ceases to be natural, but is forced into a U shape. This increases the flow time of the second heat-transfer fluid 8 in the housing 5, which increases the heat-exchange with the circulation device 2 for a first heat-transfer fluid. Conversely, the pressure drop is less optimized than in the first embodiment.

The housing 5 thus affords the heat exchanger 1, 1′ a certain modularity. Indeed, a housing 5 adapted to suit installation constraints may be chosen, notably in consideration of the pressure available for the second heat-transfer fluid, such as to prioritize limiting the pressure drop or to prioritize thermal performance.

1. A heat exchanger comprising:
a circulation device for a first heat-transfer fluid including a first-heat-transfer-fluid inlet and a first-heat-transfer-fluid outlet between which a first heat-transfer fluid flows; and
a housing containing the circulation device for the first heat-transfer fluid, the housing including:
at least one opening to be traversed by the first-heat-transfer-fluid inlet and outlet of the circulation device for a first heat-transfer fluid,
a second-heat-transfer-fluid inlet and a second-heat-transfer-fluid outlet between which a second heat-transfer fluid flows.

2. The heat exchanger as claimed in claim 1, wherein the circulation device for a first heat-transfer fluid has at least two superimposed heat-exchange tubes.

3. The heat exchanger as claimed in claim 2, wherein the heat-exchange tube foul's at least one half turn, the first heat-transfer fluid being designed to flow in parallel in the superimposed heat-exchange tubes.

4. The heat exchanger as claimed in claim 3, wherein the heat-exchange tubes are flat.

5. The heat exchanger as claimed in claim 1, wherein the circulation device for a first heat-transfer fluid has at least:
one insert interposed between two superimposed heat-exchange tubes of the circulation device for a first heat-transfer fluid, and/or
one insert interposed between a heat-exchange tube and the cover or the bottom of the housing.

6. The heat exchanger as claimed in claim 5, wherein the insert has an overall corrugated shape.

7. The heat exchanger as claimed in claim 5, wherein the insert is in contact with a lower and/or upper heat-exchange tube along a plurality of straight parallel lines.

8. The heat exchanger as claimed in claim 1, wherein the at least one opening to be traversed by the first-heat-transfer-fluid inlet and outlet is arranged on one face of the housing that is perpendicular to a lateral face in which the second-heat-transfer-fluid inlet and/or outlet are arranged.

9. The heat exchanger as claimed in claim 1, wherein the second-heat-transfer-fluid inlet and outlet are arranged between opposing lateral faces of the housing.

10. The heat exchanger as claimed in claim 1, wherein the second-heat-transfer-fluid inlet and outlet are arranged on a single lateral face of the housing.

11. The heat exchanger as claimed in claim 1, wherein the housing has a cover and a bottom that are each provided with complementary attachment means.

12. The heat exchanger as claimed in claim 11, wherein the complementary attachment means are snap-fitting means.

13. The heat exchanger as claimed in claim 11, further comprising a first ring seal interposed between the cover and the bottom of the housing.

14. The heat exchanger as claimed in claim 13, wherein one part of the housing, either the bottom or the cover, has a U-shaped peripheral end, a first arm of the U bearing the attachment means, the first ring seal being interposed between the second arm of the U and the peripheral end of the other part of the housing bearing the complementary attachment means.

15. The heat exchanger as claimed in claim 13, further comprising a second ring seal interposed between the opening in the housing and the first-heat-transfer-fluid inlet and outlet of the circulation device for a first heat-transfer fluid.

16. A thermal management facility for batteries of electric or hybrid vehicles, comprising a heat exchanger as claimed in claim 1, in which:
the first-heat-transfer-fluid inlet and outlet are connected to an air-conditioning circuit, and
the second-heat-transfer-fluid inlet and outlet are connected to a cooling water circuit for cooling the batteries.
